(19) United States
(12) Patent Application Publication
(10) Pub. No.: US 2001/0042796 A1
(43) Pub. Date: Nov. 22, 2001

(54) Shower Head

(76) Inventors: Werner Finkbeiner, Schiltach (DE); Franz Schorn, Schiltach (DE)

Correspondence Address: WILLIAM H. MURRAY, DUANE MORRIS & HECKSCHER LLP, ONE LIBERTY PLACE, PHILADELPHIA, PA, 19103-7396, US

(21) Appl. No.: 09/483,444

(22) Filed: Jan. 14, 2000

(30) Foreign Application Priority Data
Jan. 16, 1999 (DE) 19901554.6

(51) Int. Cl. B05B 1/26

(52) U.S. Cl. 239/461; 239/552

(57) ABSTRACT

A shower head contains a jet disk with a plurality of jet outlet openings. The jet outlet openings can be formed in an insert of the jet disk made from elastomeric material. For smoothing the water jets passing out of the jet outlet openings, it is proposed that jet smoothing means be positioned directly upstream or within the jet outlet openings. The jet smoothing means preferably have several partitions subdividing the jet into individual jets, so that turbulence can be calmed.

Shower heads contain water passages or ducts, which carry the water coming from the shower hose to the jet openings located in the jet disk. Water passages in shower heads are becoming ever more complicated as a result of the numerous different jet types with vented or aerated jets, massage jets, etc., as well as through the changeover devices. As a result the water leaving the jet outlet openings is very turbulent, which leads to an unattractive optical jet pattern.

The problem of the invention is to provide a shower head in which the water jets leaving the jet outlet openings have an optically attractive jet pattern.

According to the invention this problem is solved by a shower head having the features of claim 1. Further developments of the invention form the subject matter of the dependent claims, whose wording, like that of the abstract, is made by reference into part of the description.

Through the subdivision of the cross-section of the jet outlet opening it is possible to calm again the jet on traversing said jet outlet opening. Previously formed turbulence can at least partly be eliminated again as a result. The invention makes it possible to achieve an optically attractive and less splashing shower jet.

The subdivision of the cross-section can e.g. be brought about in that the jet smoothing means have at least one partition extending a certain distance in the flow direction. There can also be several partitions, which can e.g. be arranged in parallel or in the form of a cross.

The invention more particularly proposes that when there are several partitions they are radially arranged, so that the individual jet parts have roughly identical cross-sections.

According to the invention, the jet smoothing means can be located in the jet outlet opening. However, it is also possible and proposed by the invention that the jet smoothing means is located upstream of the particular jet outlet opening in the flow direction. This offers the advantage that the outlet cross-section of the jet outlet opening is not reduced, so that the calcification risk is not increased.

According to the invention, the jet smoothing means can extend over at least the length of the bore forming the jet outlet opening. The longer the jet smoothing means in the flow direction, the greater the calming of the jet.

According to the invention, it is also possible for the jet smoothing means to be longer than the jet outlet opening, particularly if the jet smoothing means commence upstream of the opening.

According to the invention, the jet smoothing means can be fitted to the jet disk and in the case of a plastic jet disk can be shaped onto the latter.

It can in particular also be provided that the jet smoothing means is constructed on a separate component, which can be so positioned in the shower head that the jet smoothing means influences the jet outlet opening.

It can in particular be provided that the jet smoothing means are located in a channel leading to the jet outlet opening.

Further features, details and advantages of the invention can be gathered from the following description of a preferred embodiment and relative to the attached drawings, wherein show:

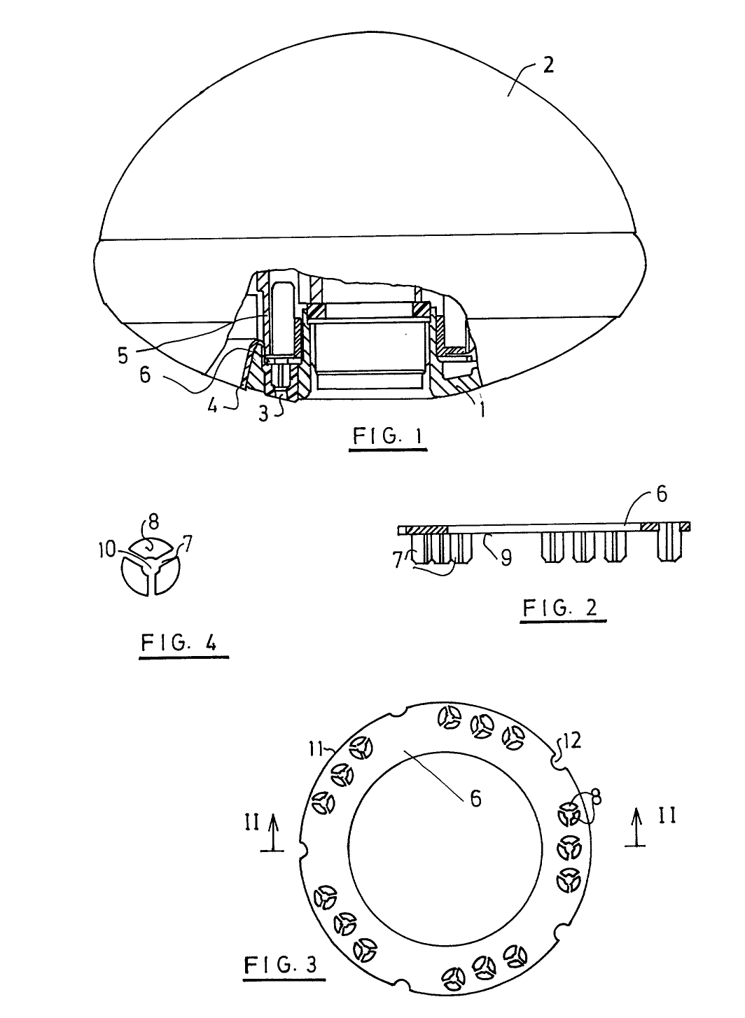

FIG. 1 A part sectional view of a shower head.

FIG. 2 A part sectional side view of an insert with a jet smoothing means.

FIG. 3 A plan view on the insert of FIG. 2 from above.

FIG. 4 On a larger scale the plan view of a jet outlet opening.

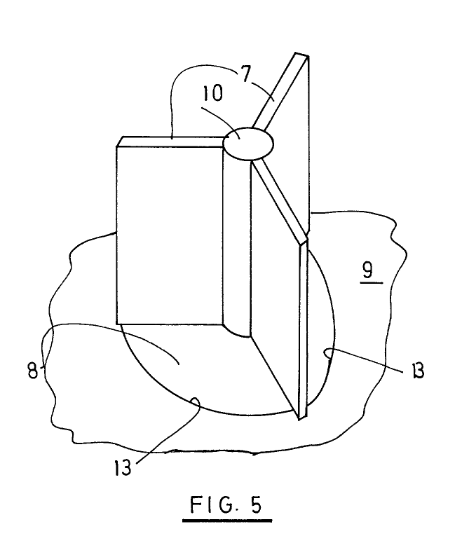

FIG. 5 On a larger scale the arrangement of a jet smoothing means on the component of FIG. 2.

FIG. 1 is a view of a shower head with an arched jet disk 1. The shower head contains a casing, together with a grip, which is not shown in the drawing, if a hand-operated shower is involved. However, the invention is not limited to hand-operated showers and also applies to head showers, side showers, etc. The shower head contains different water passages leading to the jet outlet openings 3. In the represented embodiment the jet outlet openings 3 are located in an elastomeric component 4.

Between a shower head part 5 and the component 4 containing the jet outlet openings 3 is secured an annular insert 6, because also the jet outlet openings 3 are positioned along a ring. On its outwardly directed side, at the bottom in FIG. 1, the insert 6 contains partitions 7 passing in the direction of the outflowing water. The partitions 7 are shaped onto the insert 6, which, upstream of the partitions, has perforations 8 in the flow direction. Upstream of the jet outlet openings 3 a type of channel is formed in the component 4 and in it are located the partitions 7. The water initially flows through the perforations 8 of the insert 6 and then through the jet outlet opening 3. In the area between the perforations 8 and the jet outlet opening 3 the water flows in three parallel channels, whose cross-section roughly corresponds to the sector of a circle. On passing out of the jet outlet openings 3 this leads to a smoothed, calm jet.

FIG. 2 is a side view of the aforementioned component 6. The component 6 is constructed as a circular, flat disk with the same thickness throughout and provided with groups of perforations 8. The partitions 7 are located on the side 9 facing the jet outlet openings 3. The partitions can also be located in the perforations 8. In each case three partitions 7 are constructed in the form of a star with a circular hub 10.

FIG. 3 is a plan view of the insert 6 from the direction in which the water flows to the jet outlet openings 3. The groups of perforations 8 are positioned so as to correspond to the groups of jet outlet openings 3 in the jet disk 1. To facilitate insertion, the outer edge 11 of the component 6 contains a few notches 12, which guide the insert 6 on insertion with the aid of projections in the shower head.

FIG. 5 perspectively shows the arrangement of the partitions 7 on the underside 9 of the insert 6. The three partitions extend from the central hub 10 in the outwards direction and are somewhat larger in their radial extension than the distance between the hub 10 and the edge 13 of the perforation 8. The partitions 7 are moulded in one piece to the insert 6. It is also possible for them to extend axially into the perforation 8, so that they are additionally or alternatively also moulded on the edge of the perforation 8.

1. Shower head, having a jet disk, a plurality of outlet jet openings in the jet disk and a jet smoothing means, which subdivides the cross-section of at least one jet outlet opening.

2. Shower head according to claim 1, wherein the jet smoothing means have at least one partition extending in the flow direction.

3. Shower head according to claim 2, wherein three redially positioned partitions are provided.

4. Shower head according to claim 1, wherein the jet smoothing means are located in the jet outlet opening.

5. Shower head according to claim 1, wherein the jet smoothing means are positioned upstream of the jet outlet opening.

6. Shower head according to claim 1, wherein the jet smoothing means extend at least over the length of the bore forming the jet outlet opening.

7. Shower head according to claim 1, wherein the jet smoothing means are longer than the jet outlet opening.

8. Shower head according to claim 1, wherein the jet smoothing means are moulded onto the jet disk.

9. Shower head according to claim 1, wherein the jet smoothing means are moulded onto a separate insert.

10. Shower head according to claim 1, wherein the jet smoothing means are located in a channel leading to the jet outlet opening.

11. Shower head according to claim 1, wherein the jet smoothing means are made of a ridig material.
